(19) United States
(12) Patent Application Publication
(10) Pub. No.: US 2006/0200838 A1
(43) Pub. Date: Sep. 7, 2006

(54) Pick-up drive apparatus for disc player

(75) Inventors: Takashi Yamanaka, Tokyo (JP); Toshio Yoshimura, Kanagawa-ken (JP); Akeshi Shitamichi, Tokyo (JP)

Correspondence Address: BACON & THOMAS, PLLC, 625 SLATERS LANE, FOURTH FLOOR, ALEXANDRIA, VA, 22314, US

(73) Assignee: Tanshin Denki Co., Ltd., Tokyo (JP)

(21) Appl. No.: 11/368,431

(22) Filed: Mar. 7, 2006

(30) Foreign Application Priority Data
Mar. 7, 2005 (JP) 2005-061951

(51) Int. Cl. G11B 21/02; G11B 7/08

(52) U.S. Cl. 720/676; 720/663

(57) ABSTRACT

The invention is a proposal of a pick-up drive apparatus for a disc player, which permits reducing the rotation resistance offered by a feed screw for driving a pick-up. A guide shaft and a feed screw are disposed side by side. an engagement part of a coupling member is held in radial and elastically forced contact with the feed screw. With rotation of the feed screw, the coupling member is thus advanced and retreated in the axial directions of the feed screw. A pick-up seat carrying a pick-up is caused to follow the coupling member for advancement and retreat along the guide shaft. The coupling member is mounted on the guide shaft for rocking movement and axial advancement and retreat. The coupling member has a pair of clamping pieces clamping the feed screw from the opposite sides in the direction of rocking movement. The engagement part is formed on one of the clamping members.

### BACKGROUND OF THE INVENTION

1. Field of the Invention

This invention relates to pick-up drive apparatus for disc player, in which a pick-up is movably mounted on a play-back base.

2. Description of the Prior Art

A pick-up serving to play back a disc is mounted on a pick-up seat and movably disposed together with the pick-up seat on a play-back base. In a pick-up drive apparatus shown in Japanese Patent Disclosure No. 2003-263846, a guide shaft supporting a pick-up seat and a feed screw with a motor torque transmitted thereto for rotation after speed reduction are both mounted on a play-back base such as to be directed in the radial direction of a disc. The feed screw has its opposite ends supported for rotation in bearings, respectively. The pick-up seat and the feed screw are elastically coupled together by an elastic member. The elastic member is in contact with the feed screw, and reliably transmits even very slight rotation of the feed screw to the pick-up seat.

In the meantime, for simplifying the arrangement it is thought that the above pick-up drive apparatus incorporates what serves both the guide shaft and the feed screw. Japanese Patent Disclosure No. 2002-230924 shows an arrangement, in which a feed screw also serves as a main shaft 103, which is pushed by a bias spring 2 against a main bearing 1 1 integral with a pick-up seat.

In the case of the Japanese Patent Disclosure No. 2003-263846, in which the pick-up seat is supported on the guide shaft, and the pick-up base and the feed screw are coupled together by the elastic member, the bearings supporting the opposite ends of the feed screw bear the elastic force of the elastic member. Therefore, the bearings experience rotation load when the feed screw is rotated. The rotation load is applied to a feed screw drive motor. This means that a high output or large powered motor is required.

In the case of the Japanese Patent Disclosure No. 2002-230924, in which the guide shaft also serves as feed screw, the bearings supporting the opposite ends of the feed screw (i.e., main shaft) do not experience any elastic member load. It is thus possible to use a low output or small powered motor. However, in the case of using a guide shaft which also serves as feed screw, the feed screw requires high accuracy mechanical processing, resulting in increased cost of the feed screw.

Accordingly, an arrangement featuring both the merits is conceivable, in which the pick-up seat is supported on the guide shaft and the feed screw is pushed by the elastic member against the pick-up seat. In this system, however, it is predictable that, unless the parallel degree of the guide shaft and the feed screw and the inter-axial distance between the two are extremely accurately set up, the pick-up seat guided by the guide shaft is strongly in contact with the feed screw. In this case, a hazardous high rotation resistance may be generated in the bearings supporting the two ends of the feed screw, and it is possible to adopt a low output motor. Particularly, since the optical axis of the pick-up is made to be normal to the disc, by arranging that the mounting angle of the guide shaft with respect to the play-back base is adjustable, the relative positions of the feed screw and the guide shaft are changed by the adjustment. It is thus impossible to adopt this system.

An object of the invention is to provide a pick-up drive apparatus for a disc player, which can reduce the rotation load on the feed screw and permit cost reduction of the feed screw.

### SUMMARY OF TE INVENTION

According to the invention, a coupling member coupling a feed screw and a pick-up seat is mounted on a guide shaft for rocking movement about the same and advancement and retreat in the axial directions of the guide shaft. The coupling member has a pair of clamping pieces clamping the feed screw on the opposite sides in the direction of rocking movement. One of the clamping pieces has an engagement part in engagement with the feed screw. With this arrangement, changes in the relative positions of the guide shaft and the feed screw are allowed by the rocking movement of the coupling member and changes in the position of contact of the engagement part with the feed screw.

Also, according to the invention, the coupling member has a securing part for securing it to the pick-up seat and a pair of clamping pieces clamping the feed screw from the opposite sides in the direction of rocking movement. A reduced thickness part is formed between the securing part and the clamping pieces, and the engagement part is formed on one of the clamping parts. With this arrangement, changes in the relative positions of the guide shaft and the feed screw are allowed by rocking movement of the coupling member and changes in the position of contact of the engagement part with the feed screw.

Furthermore, according to the invention, the coupling member is supported to be rocked on the feed screw. The coupling member is provided with an elastic arm in elastic contact with the pick-up seat in the axial direction of the guide shaft, and also has an engagement piece for maintaining the state of contact of the elastic arm and the pick-up seat with each other. With this arrangement, changes in the relative positions of the guide shaft and the feed screw are allowed by rocking movement of the coupling member and changes in the position of contact of the engagement part with the feed screw.

Still further, according to the invention, the coupling member is mounted for rocking movement on the pick-up seat such as to stride a central axis of the feed screw, and it has a pair of clamping parts clamping the feed screw from the opposite sides in the direction of rocking movement, the engagement part being formed on one of the clamping pieces. With this arrangement, changes in the relative positions of the guide shaft and the feed screw are allowed by rocking movement of the coupling member and changes in the position of contact of the engagement part with the feed screw.

Yet further, such options as possible as mounting the guide shaft on the play-back base such that the mounting distance thereof with respect to the guide shaft is adjustable, as forming the feed screw from a plastic or synthetic resin material and as providing an elastic member for pushing one of the coupling pieces of the coupling member against the feed screw.

According to the invention, by merely supporting the coupling member for rocking movement on the guide shaft, changes in the relative positions of the guide shaft and the feed screw can be allowed by rocking movement of the elastic member and changes in the position of contact of the engagement part with the feed screw. Also, according to the invention, by merely securing the securing part of the coupling member to the pick-up seat, changes in the relative positions of the guide shaft and the feed screw can be allowed by rocking movement of the elastic member and changes in the position of contact of the engagement part with the feed screw.

Furthermore, according to the invention, by merely supporting the coupling member for rocking movement on the feed screw and maintaining the state of contact of the elastic arm of the coupling member and the pick-up seat with each other with the engagement piece, changes in the relative positions of the guide shaft and the feed screw can be allowed by rocking movement of the elastic member and changes in the position of contact of the engagement part with the feed screw.

Still further, according to the invention, by merely mounting the coupling member for rocking movement on the pick-up seat such as to stride a central axis of the feed screw, changes in the relative positions of the guide shaft and the feed screw can be allowed by rocking movement of the elastic member and changes in the position of contact of the engagement part with the feed screw.

Owing to the above results, the forces of the pair of clamping pieces to clamp the feed screw do not apply any excess load on the bearings supporting the opposite ends of the feed screw. Also, any change in the relative positions of the guide shaft and the feed screw is not applied to the bearings supporting the opposite ends of the feed screw. Thus, it is possible to cause displacement of the pick-up with a low output motor. Also, by forming the feed screw from a plastic material, it is possible to permit cost reduction of the pick-up drive apparatus.

### BRIEF DESCRIPTION OF THE DRAWINGS

The invention will become more apparent upon a reading of the following detailed description with reference to the accompanying drawings, in which:

FIG. 1 is a plan view showing a disc player using a first embodiment of the pick-up drive apparatus according to the invention;

FIG. 2 is a side view showing of an essential part of the first embodiment of the pick-up drive apparatus;

FIG. 3 is a perspective view showing an essential part of the first embodiment of the pick-up drive apparatus;

FIG. 4 is a side view showing of an essential part of a second embodiment of the pick-up drive apparatus;

FIG. 5 is a plan view showing a disc player using a third embodiment of the pick-up drive apparatus according to the invention;

FIG. 6 is a side view showing of an essential part of the third embodiment of the pick-up drive apparatus;

FIG. 7 is a plan view showing a disc player using a fourth embodiment of the pick-up drive apparatus according to the invention;

FIG. 8 is a side view showing an essential part of the fourth embodiment of the pick-up drive apparatus;

FIG. 9 is a play view showing a disc player using a fifth embodiment of the pick-up drive apparatus according to the invention;

FIG. 10 is an exploded perspective view showing a coupling member in the fifth embodiment of the pick-up drive apparatus; and

FIG. 11 is a perspective view showing a feed screw according to the invention.

### DESCRIPTION OF THE PREFERRED EMBODIMENTS

In the pick-up drive apparatus for a disc player according to the invention, a coupling member in elastic engagement with a feed screw is advanced and retreated in the axial directions of the feed screw with rotation thereof, and a pick-up seat is adapted to follow the coupling member for advancement and retreat along a guide shaft. The coupling member is supported on either of the guide shaft, the pick-up seat or the feed screw for rocking movement in directions normal to the guide shaft. The coupling member is in engagement with a counterpart member not supporting it such as not to interfere with it.

### First Embodiment

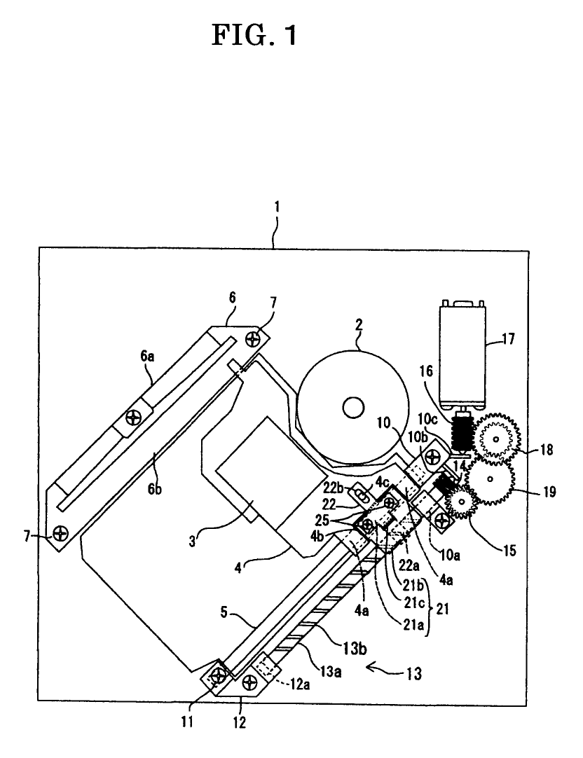

A first embodiment of the pick-up drive apparatus for a disc player according to the invention will now be described with reference to FIGS. 1 to 3. FIG. 1 is a plan view of the pick-up drive apparatus taken from the back surface side of a play-back base 1. A disc (not shown) is loaded on the back surface. Mounted for advancement and retreat on the play-back base 1, are a turntable motor 2 and a pick-up 3, which extends from the neighborhood of the turntable motor 2 toward a corner of the play-back base 1 and serves to play back a disc. The pick-up 3 is supported on one side on a pick-up seat 4, which is supported on one side thereof on a guide shaft 5, and supported on the other side on a guide plate 6. The guide plate 6 is formed from a thin metal sheet, and it has an arm part 6a becoming spaced apart from the surface of the play-back base 1 as one goes from the center toward both ends, and also has a flat part 6b coupling together the two ends of the arm part 6a in flat form. The guide plate 6 is secured at its center to the play-back base 1. The flat part 6b is supported such that the height of its both ends from the surface of the play-back base 1 is adjustable with first adjustment screws 7. The above other side of the pick-up seat 4 is in engagement with the flat part 6b such as to clamp the thickness thereof.

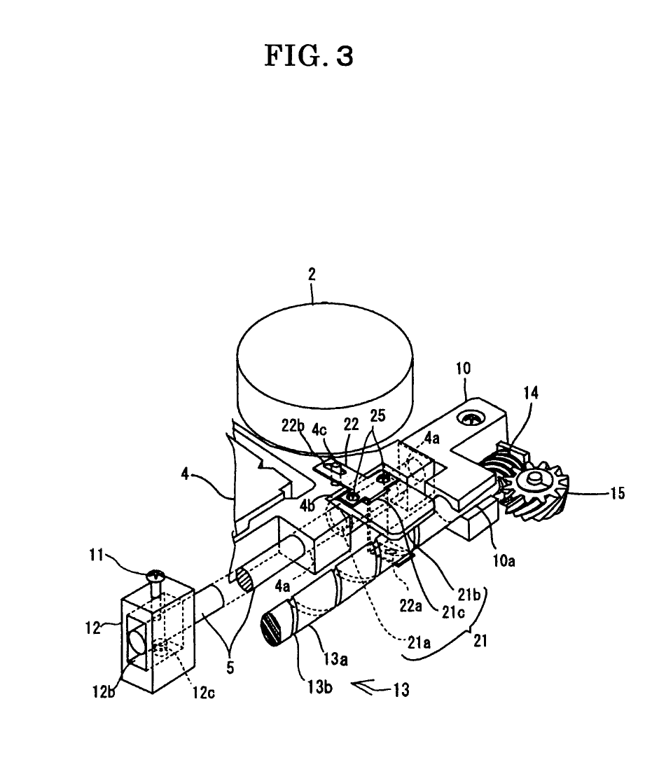

The guide shaft 5 is secured at one end nearer the turntable motor 2 by a first securing member 10 to the play-back base 1, and mounted at the other end by a second securing member 12 on a corner side of the play-back member 1. As shown in FIG. 3, the second securing member 12 has an angular hole 12b, through which the guide shaft 5 is inserted. The angular hole 12b is such elongate that the guide shaft 5 is spaced apart from the play-back base 1. A spring 12c is interposed between the bottom of the angular hole 12b and the guide shaft 5, and a second adjustment screw 11 is screwed into the second securing member 12 from the outside thereof such as to push the guide shaft 5 against the spring 12c. By turning the second adjustment screw 11, the height of the other end of the guide shaft from the surface of the play-back base 1 can be adjusted. The guide shaft 5 is a high straight advancement accuracy rod formed from a stainless steel material having a diameter of 3 millimeters and having a polished outer periphery. The pick-up seat 4 has two guide holes 4a formed at positions spaced apart a predetermined distance for being highly accurately fitted on the guide shaft 5. An intervening space 4b is formed between the two guide holes 4a.

As shown in FIG. 1, a feed screw 13 is disposed close and substantially parallel to the guide shaft 5. The feed screw 13 is made of a plastic or synthetic resin material, and includes a screw body 13a and a helical gear 14 coupled to one end of the screw body 13a. The screw body 13a has a peripheral helical groove 13b. The feed screw 13 is fitted for rotation at one end in a hole 10a formed in the first securing member 10 and fitted for rotation at the other end in a hole 12a formed in the second securing member 12. The above other end of the feed screw 13 is adapted not to be in contact with the bottom of the hole 12a. The helical gear 14 has a protuberance, at the free end thereof, tapering toward the center. On the play-back base 1 is provided with a gear 15 which is in mesh with the helical gear 14. A pick-up driving motor 17 is provided with an output shaft on which a worm gear 16 is mounted. The worm gear 16 is in mesh with a worm wheel 18. The worm wheel 18 is connected through an intermediate gear 19 to the gear 15. The rotation power of the motor 17 is transmitted through said worm gear 16, worm wheel 18, intermediate gear 19, gear 15 and helical gear 14 to the feed screw 13 with a reduced rotation rate. The first securing member 10 has a first tongue 10b (elastic member) for pushing the free end of the protuberance in the axial direction to axially bias the feed screw 13 at one end thereof, thereby restricting the axial play of the feed screw 13. Further, the first securing member 10 has a second tongue 10c (elastic member). The worm gear 16 has a protuberance, at the free end thereof, tapering toward the center. The second tongue 10c serves to push the free end of the protuberance of the worm gear 16 to axially bias the worm gear 16 at the end thereof, thereby restricting the axial play of the worm gear 16. By the first and second tongues 10b and 10c, the rotation of the motor 17 can be transmitted to the feed screw 13 without any rotation loss, so that these restriction actions by both tongues 10b and 10c permit the pick-up 3 to accurately play back the disc (not shown).

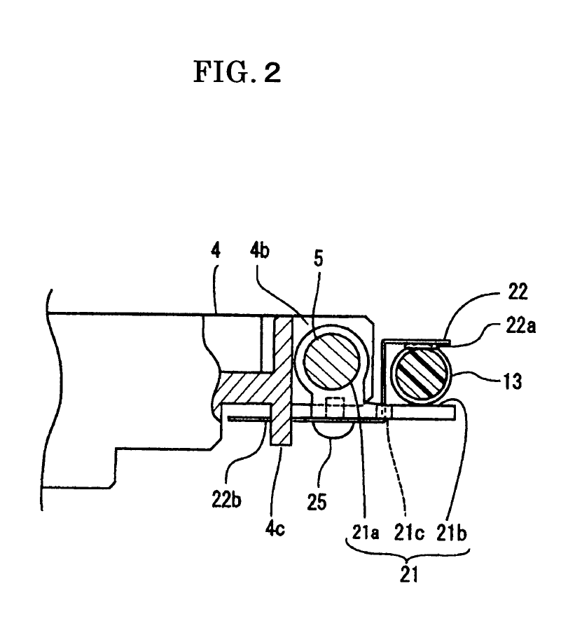

As shown in FIG. 2, in the intervening space 4b of the pick-up seat 4, a base member 21 (i.e., coupling member) is mounted on the guide shaft 5. The base member 21 has a mounting hole 21a fitted on the guide shaft 5, a flat sheet-like part 21b (i.e., clamping piece) in contact with the periphery of the feed screw 13, a threaded hole for mounting a leaf spring 22 (i.e., clamping piece) and a slit 21c, which is formed at a position between the feed screw 13 and the guide shaft 5, and through which the leaf spring 22 is inserted. The leaf spring 22 mounted on the base member 21, has a crank-like bent shape when viewed in the axial direction of the guide shaft 5. One end part of the leaf spring 22 has a screw hill 22a(i.e., engagement part) in mesh with the helical groove 13b of the feed screw 13. The other end part of the leaf spring 22 has an elongate slot 22b extending normal to the axis of the guide shaft 5. The slot 22b has a width identical with the diameter of a small cylindrical post 4c projecting from the pick-up seat 4. The screw hill 22a is shaped as a tooth of a spur gear.

As shown in FIG. 2, by inserting one end of the leaf spring 22 through the slit 21c, the screw hill 22a reaches a position to clamp the feed screw 13 between it and the flat sheet-like part 21b. Also, the slot 22b at the other end reaches a position that the small post 4c can be engaged in it. By securing the leaf spring 22 to the base member 21 with a set screw 25, one end of the leaf spring 22 undergoes elastic deformation to push the screw hill 22a into the helical groove 13b. Consequently, the flat sheet-like part 21b and the screw hill 22a oppose in parallel with each other such as to diametrically clamp the feed screw 13, and do not prevent displacement of the feed screw 13 in parallel with the screw hill 22a. Also, when the slot 22b is fitted on the small post 4c and the leaf spring 22 is displaced in the axial direction of the guide shaft 5 with rotation of the feed screw 13, the slot 22b pushes the small post 4c to cause displacement of the pick-up seat 4 in the axial direction of the guide shaft 5. When the base member 21 experiences a force tending to cause its rocking movement, the small post 4c slides along the slot 22b, thus allowing rocking movement of the base member. At this time, a rotation load on the feed screw 13 is generated by the spring pressure of the tongue 10b and the spring pressure of the leaf spring 22 clamping the periphery of the feed screw 13.

In the state of FIG. 3, by turning the second adjustment screw 11 for tilt adjustment of bringing the optical axis of the pick-up 3 to be normal to the disc surface, the height of the other end of the guide shaft 5 from the surface of the play-back base 1 is changed to change the relative positions of the guide shaft 5 and the feed screw 13. At this time, the base member 21 is revolved about the guide shaft 5 according to this change. Also, by turning the first adjustment screws 7 of the guide plate 6, the pick-up seat 4 is rocked about the guide shaft 5 to change the relative positions of the guide shaft 5 and the feed screw 13. According to these changes, the inter-axis distance between the guide shaft 5 and the feed screw 13 is changed. However, this change is absorbed by a change in the contact position of the feed screw 13 and the screw hill 22a, and does not extend to the holes 10a and 12a, in which he feed screw 13 is supported. Thus, the tilt adjustment can be made without increase of rotation load on the holes 10a and 12a, in which the feed screw 13 is supported.

As shown above, since the holes 10a and 12a supporting the rotation of the feed screw 13 is free from change in load accompanying the tilt adjustment, the rotation resistance of the feed screw 13 is not increased. It is thus possible to rotate the feed screw 13 with a low output or small powered motor 17. Also, the feed screw 13 can be formed from a plastic material having inferior mechanical strength in that the pick-up seat 4 is supported by the guide shaft 5 and that the feed screw 13 is clamped between the flat sheet-like part 22b and the leaf spring 22.

### Second Embodiment

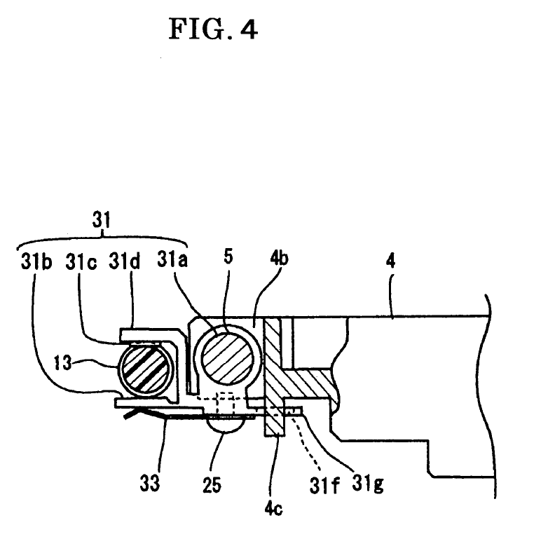

FIG. 4 shows a second embodiment, which is a modification of the first embodiment such that the screw hill is formed on the base member. The same parts as those in the first embodiment are designated by like reference numerals and symbols. A base member 31 which has a mounting hole 31a fitted on the guide shaft 5, has a sheet-like part 31a (i.e., clamping piece) in contact with the periphery of the feed screw 13 and a securing part 31d (i.e., clamping part) having a screw hill 31c (i.e., engagement part) screwed in the helical groove 13a of the feed screw 13. The sheet-like part 31b has a reduced thickness stem part flexibly coupled to the base member 31. The sheet-like part 31b and the securing part 31d face each other such as to diametrically clamp the feed screw 13. The base member 31 has an integral arm 31g having an elongate slit 31f extending normal to the axis of the guide shaft 5. The slit 32f has a width identical with the diameter of the small cylindrical post 4c projecting from the pick-up seat 4. A leaf spring 33 is mounted by a seat screw 25 on the base member such as to push the tip of the sheet-like member 31b against the feed screw 13. By forming the screw hill 31c from a plastic material such as to be integral with the base member 31 as in this second embodiment, it is possible to smoothly finish the screw hill 31c to fit the groove shape of the helical groove 13b and further reduce the rotation load on the feed screw 13.

While in the first and second embodiments the feed screw 13 is formed from a plastic material, it is possible as well to use metal feed screw. Also, in the first embodiment the screw hill 22a is formed on the leaf spring 22, it is possible as well to provide a screw hill on the sheet-like part 31b of the base member 31. Furthermore, while the screw hill 31c is mounted by the set screw 25 on the base member, it is possible as well to pressure fit a hole formed in the leaf spring 22 onto a shaft provided on the base member 31. Still further, it is possible as well to mount the leaf spring by fire collapsing the shaft. In the first and second embodiments the sheet-like part 21b and the securing piece 31d are held pushed by the leaf spring 22 against the periphery of the feed screw 1. By so doing, the sheet-like part 21b and the securing piece 31d can prevent flexing of the feed screw 13, which is made of a plastic material of low mechanical strength, by the pushing force of the leaf spring 22. Since the flexing of the feed screw is prevented, the holes 10a and 12a supporting the feed screw 13 are subject to no rotation load increase.

### Third Embodiment

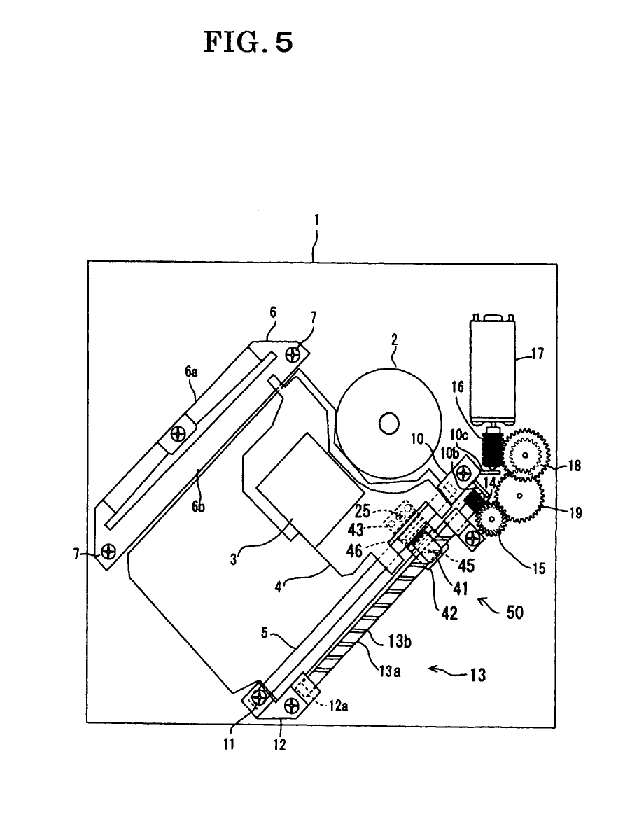

FIG. 5 shows a third embodiment of the pick-up drive apparatus according to the invention. The same parts as those in the first embodiment will be designated by like reference numerals and symbols. Play-back base 1 carries a turntable motor 2 and a pick-up 3 for playing back a disc. The pick-up 3 is supported on one side on a pick-up seat 4, which is supported on one side thereof on guide shaft 5, and supported on the other side on a guide plate 6. The guide plate 6 is secured at its center to the surface of the play-back base 1, and its opposite ends are held by first adjustment screws 7 at positions spaced apart from the surface of the play-back base 1.

The guide shaft 5 is secured at an end nearer the turntable motor 2 by a first securing member 10 to the play-back base 1, and mounted at the other end by a second securing member 12 on the play-back base 1. The height of the other end of pick-up seat 4 from the surface of the play-back base 1 is adjustable by turning the first adjustment screws 7. The pick-up seat 4 has two guide holes 4a formed at positions spaced apart a predetermined distance for being highly accurately fitted on the guide shaft 5. An intervening space 4a is formed between the two guide holes 4a.

A feed screw 13 is disposed close and substantially parallel to the guide shaft 5. The feed screw 13 is made of a plastic material, and has a peripheral helical groove 13b. The feed screw 13 is fitted for rotation at one end in a hole 10a formed in the first securing member 10 and fitted for rotation at the other end in a hole 12a formed in the second securing member 12. The other end of the feed screw 13 is not in contact with the bottom of the hole 12a. A helical gear 14 has a free end protuberance tapering toward the center. The first securing member 10 has a tongue 10b for pushing the free end of the protuberance in the axial direction.

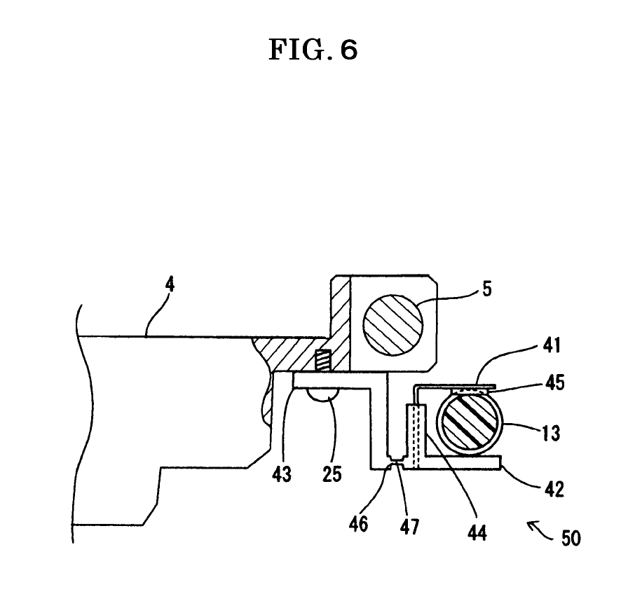

As shown in FIG. 6, a base member 50 (i.e., coupling member) having a pair of clamping pieces 41 and 42 diametrically clamping the feed screw 13, is mounted by a set screw 25 on the pick-up seat 4 carrying the pick-up 3. Of the pair of clamping pieces 41 and 42, the first clamping piece 41 is constituted by a thin leaf spring material, and the second clamping piece 42 is made of aplastic material integral with a securing part 43. The second clamping piece 42 has a coupling part 44 extending upright from one end of it, and the first clamping member 41 is mounted on the coupling part 44. The clamping piece 41 has a screw hill 45 (i.e., engagement part), which is engaged in the helical groove 13b of the feed screw 13. The distance between the second clamping piece 42 and the tip of the screw hill 45 is narrower than the valley diameter of the helical groove 13b. Thus, when the feed screw 13 is inserted through the space between the second clamping piece 42 and the screw hill 45, the first clamping piece 41 is elastically displaced, and with its elastic force the two clamping pieces 41 and 42 clamp the feed screw 14.

The above screw hill 45 has substantially the same shape as a tooth of a spur gear, and does not prevent displacement of the feed screw 13 to be parallel with the first clamping member 41. Between the securing part 43 of the base member 50 and the second clamping piece 42, an elongate grooves 46 (i.e., reduced thickness part) are formed from both the surfaces of the base member 50 such as to be parallel with the guide shaft 5. The grooves 46 are spaced apart by a thickness of about 0.3 millimeter, a thickness close to the processing limit of plastic or synthetic resin molding. Both the clamping members 41 and 42 are thus capable of being rocked about the center between the grooves 46 as center of rocking movement.

Referring to FIG. 5 again, by turning the first adjustment screws 7 for tilt adjustment, the height of the pick-up seat 4 carrying the pick-up 3 from the surface of the play-back base 1 is changed to cause rocking movement of the pick-up seat 4 about the guide shaft 5, thus changing the distance between the pick-up seat 4 and the feed screw 13. This change causes rocking movement of the pair of clamping pieces 41 and 42 of the base member 50 about the center 47 of rocking movement. At this time, the force of the pair of clamping pieces 41 and 42 to clamp the feed screw 13 is not changed.

Since the clamping pieces 41 and 42 do not prevent displacement of the feed screw 13 to be parallel with them, any change in the distance between the guide shaft 51 and the feed screw 13 accompanying the tilt adjustment does not increase the rotation load on the feed screw 13. Also, since the thickness between the two grooves 46 is very small, no change in the load accompanying the tilt adjustment occurs on the holes 10a and 12a supporting the rotation of the feed screw 13. It is thus possible to rotate the feed screw 13 with the low output or small powered motor 17. While in this embodiment the elongate grooves 46 are formed between the securing part 43 and the second clamping piece 42, it is possible as well to couple the securing part 43 and the second clamping piece 42 with a thin bar or the like.

### Fourth Embodiment

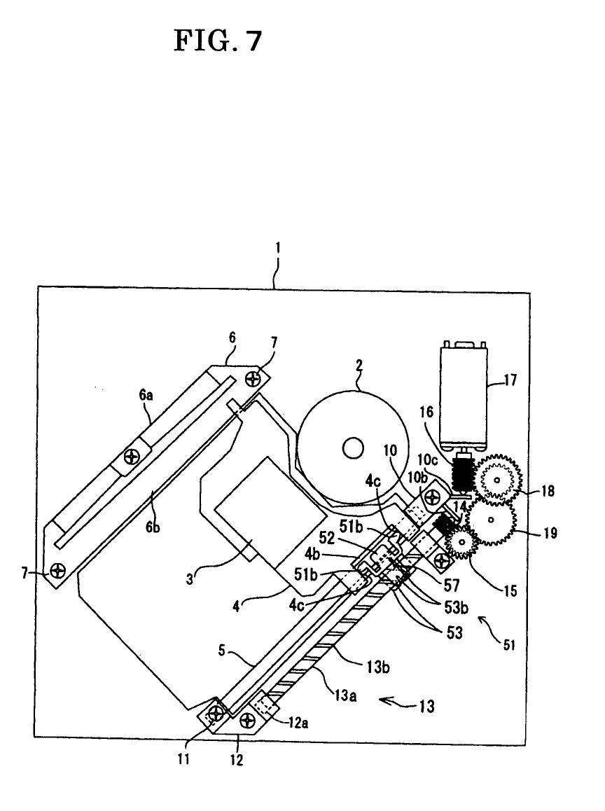

FIG. 7 shows a fourth embodiment of the pick-up drive apparatus according to the invention. The same parts as those in the first embodiment are designated by like reference numerals and symbols. A play-back base 1 carries a turntable motor 2 and a pick-up 3 for playing back a disc. The pick-up 3 is supported at one end on pick-up seat, which is supported on one side thereof on guide shaft 5, and supported at the other end on a guide plate 6. The guide shaft 5 is secured at one end nearer the turntable motor 2 by a first securing member 10 to the play-back base 1 and mounted at the other end by a second securing member 12, which has its mounting height from the play-back base 1 adjustable by second adjustment screw 11, on the play-back base 11. By turning the second adjustment screw 11, the height of the other end of the guide shaft 5 from the surface of the play-back base 1 is adjustable. The pick-up seat 4 has two guide holes 4a formed at positions spaced apart a predetermined distance for being highly accurately fitted on the guide shaft 5. An intervening space 4b is formed between these two guide holes 4a.

The feed screw 13 is disposed close and parallel to the guide shaft 5. Feed screw 13 is made of a plastic material, and has a helical groove 13b formed on the periphery. The feed screw 13 is fitted at one end for rotation in a hole 10a formed in the first securing member 10 and fitted at the other end for rotation in a hole 12a of the second securing member 12. A coupling member 51 is fitted on the feed screw 13. The coupling member 51 has a pair of elastic pieces 51b (i.e., elastic arms), which are brought into light elastic contact with opposed walls 4c of the intervening space 4b formed in the pick-up seat 4 when it is inserted through the intervening space 4b.

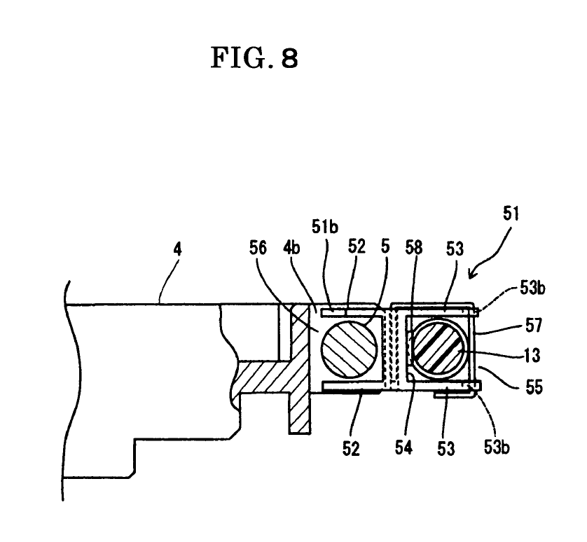

As shown in FIG. 8, the coupling member 51 has a pair of contact pieces 52 (i.e., engagement pieces) capable of being brought into contact with the periphery of the guide shaft 5 from the opposite sides thereof. The contact pieces 52 have the above elastic pieces 51b, respectively. The coupling member 51 also has a pair of contact pieces 53 in contact with the periphery of the feed screw 13 from the opposite sides thereof. The coupling member 51 further has a coupling piece 54 intervening between the pair of contact pieces 52 and the pair of contact pieces 53 and coupling together these contact pieces 52 and 53 into a one-piece member. The cross sectional profile of the coupling member 51 along the axial direction of the guide shaft 5 is thus a figure of two combined angular U shape which is opened on both sides thereof, permitting the feed screw 13 to be disposed on one of the open spaces 55 and the guide shaft 5 to be disposed in the other open space 56. After the feed screw 13 has been disposed in the open space 55, the opening thereof is closed by a rod spring 57. The rod spring 57 is hooked in slits 53b formed in the pair of contact pieces 53 such that it extends in a direction normal to the inclination angle of the helical groove 13b. The coupling piece 54 has a straight screw hill 58 (i.e., engagement part) in mesh with the helical groove 13b of the feed screw 13. When closing the open space 55, the rod spring 57 pushes the helical groove 13b of the feed screw 13 against the screw hill 58.

The other open space 56 is such that the width dimension between the pair of contact pieces 52 is slightly larger than the diameter of the guide shaft 5, so that it permits easily disposing of the guide shaft 5 in it. When the coupling member 51 is rocked about the feed screw 13, the contact pieces 52 are brought into contact with the guide shaft 5 to restrict the rocking range of the coupling member 51. This rocking range is set up such that the elastic pieces 51b are retained in the intervening space 4b of the pick-up seat 4. By disposing the feed screw 13 in the open space 55 and closing the opening thereof with the rod spring 57, the coupling member 51 is supported on the feed screw 13. Also, by disposing the guide shaft 5 in the other open space 56, the elastic pieces 51b are inserted through the intervening space 4b while being slightly deformed. With the disposing of the guide shaft 5, the coupling member 51 is coupled thereto such that it can be rocked in a predetermined rocking range. Also, with the fitting of the elastic pieces 51b in the intervening space 4b, the coupling member 51 is coupled to and made integral with the pick-up seat 4.

Referring to FIG. 7 again, by turning the second adjustment screw 11 for tilt adjustment, the height of the other end of the guide shaft 5 from the surface of the play-back base 1 is changed to change the relative positions of the guide shaft 5 and the feed screw 13. According to this change, the coupling member 51 is rocked about the feed screw 13. By turning the first adjustment screws 7 of the guide plate 6, the relative positions of the guide shaft 5 and the feed screw 13 are changed. According to this change, the coupling member 51 can be rocked about the feed screw 13. The change in inter-shaft distance between the guide shaft 5 and the feed screw 13 accompanying the tilt adjustment is absorbed by a change in the position of contact of the elastic pieces 51b and the pick-up seat 4 with one another. At this time, the clamping force of the rod spring 57 applied to the feed screw 13 is not changed. As shown, the holes 10a and 12a supporting the rotation of the feed screw are free from any change in the load accompanying the tilt adjustment, and the rotation load on the feed screw 13 is not increased. It is thus possible to rotate the feed screw 12 with a low output or small powered motor 17.

### Fifth Embodiment

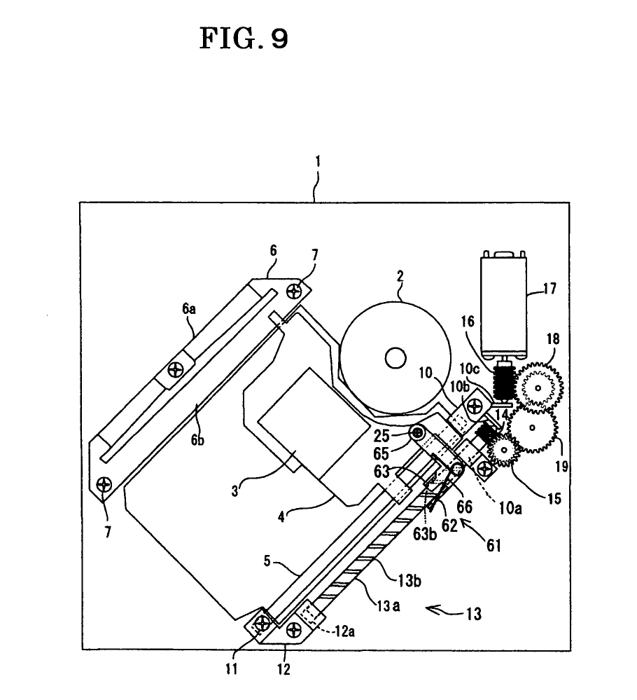

FIG. 9 shows a fifth embodiment of the pick-up drive apparatus according to the invention. The same parts as those in the first embodiment are designated by like reference numerals and symbols. A play-back base 1 carries a turntable motor 2 and a pick-up for playing back a disc. The pick-up 3 is supported at one side on a pick-up seat 4, which is supported at one end thereof on a guide shaft 5, and supported at the other end on a guide plate 6. The guide plate 6 is secured at its center to the surface of the play-back base 1, and its opposite ends are held by a first adjustment screws 7 at a position spaced apart from the surface of the play-back base 1.

The guide shaft 5 is secured at one end nearer the turntable motor 2 by first securing member 10 to the play-back base 1 and mounted at the other end by a second securing member 12, which is capable of adjusting its mounting height from the play-back base 1, to the play-back base 1.

By turning first and second adjustment screws 7 and 11, the height of the other end of the guide shaft 5 from the surface of the play-back base 1 can be adjusted. Feed screw 13 is disposed close and parallel to the guide shaft 5. The feed screw 13 has substantially the same length as the guide shaft 5, and has peripheral helical groove 13b. The feed screw 13 is fitted at one end for rotation in a hole 10a formed in the first securing member 10 and fitted at the other end for rotation in a hole 12a of the second securing member 12.

As shown in FIG. 9, an L-shaped arm 61 (i.e., coupling member) made of a plastic material is mounted for rocking movement by a set screw 25 on the pick-up seat 4 supporting the pick-up 3 The L-shaped arm 61 has a pair of clamping pieces 62 and 63 diametrically clamping the feed screw 13. The clamping piece 72 is formed at one end of the L-shaped arm 61, and the other clamping piece 63 is formed at a middle position spaced apart from the above end. The clamping piece 63 has a screw hill 63b(i.e., engagement part) engaged in the helical groove 13b of the feed screw 13. The distance between the two clamping pieces 62 and 63 is set up to be slightly smaller than the diameter of the feed screw 13. When the feed screw 13 is inserted into the space between the two clamping pieces 62 and 62, the clamping piece 62 undergoes an elastic displacement, and with this elastic force the clamping pieces 62 and 63 clamp the feed screw 13. The clamping pieces 62 and 63 do not prevent displacement of the feed screw 13 to be parallel with them.

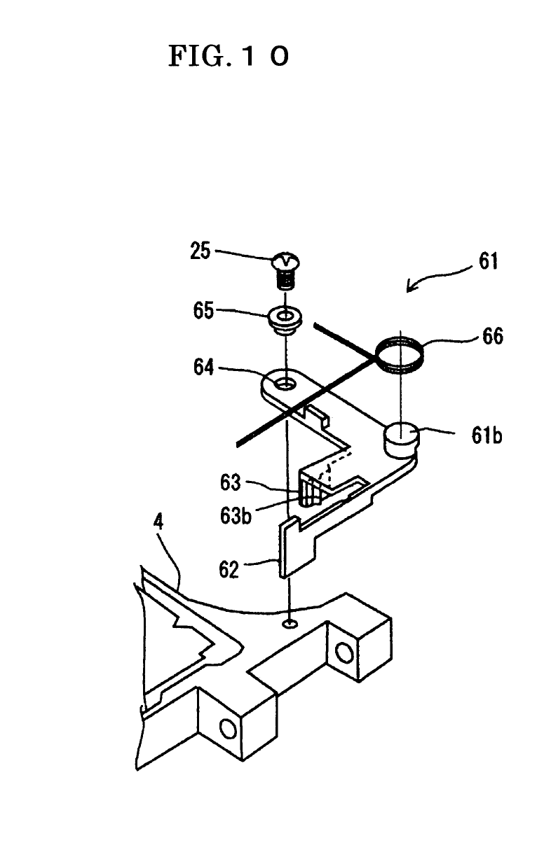

As shown in FIG. 10, the other end part of the L-shaped arm 61 has a hole 64 for the mounting thereof on the pick-up seat 4. A bearing 65 capable of supporting the L-shaped arm 61 for rocking movement is fitted in the hole 64. The bearing 65 is screwed by the set screw 25 to the pick-up seat 4. The L-shaped arm 61 has a hook 61b for mounting an assisting spring 66 (i.e., elastic member) made of metal wires. The assisting spring 66 is hooked on the hook 61b. By using this assisting spring 66, the forces of the two clamping pieces 62 and 63 for clamping the feed screw 13 can be made stable.

Referring to FIG. 9 again, by turning the second adjustment screw 11 for tilt adjustment, the height of the other end of the guide haft 5 from the surface of the play-back base 1 is changed to change the relative positions of the guide shaft 5 and the feed screw 13. At this time, the feed screw 13 is displaced in parallel with the pair of clamping pieces 62 and 63. However, since the two clamping pieces 62 and 63 do not prevent the displacement of the feed screw 13, the rotation load thereon is not changed with this displacement. By turning the first adjustment screws 7 of the guide plate 6, the pick-up seat 4 is rocked about the guide shaft 5 to change the relative positions of the guide shaft 5 and the feed screw 13. With this rocking movement, the pair of clamping pieces 62 and 63 cause rocking movement of the L-shaped arm about the bearing 66 again. Thus, the rotation load on the feed screw 13 is not increased with the tilt adjustment. Thus, it is possible to rotate the feed screw 13 with low output motor 17 irrespective of the parallel degree of the guide shaft 5 and the feed screw with each other.

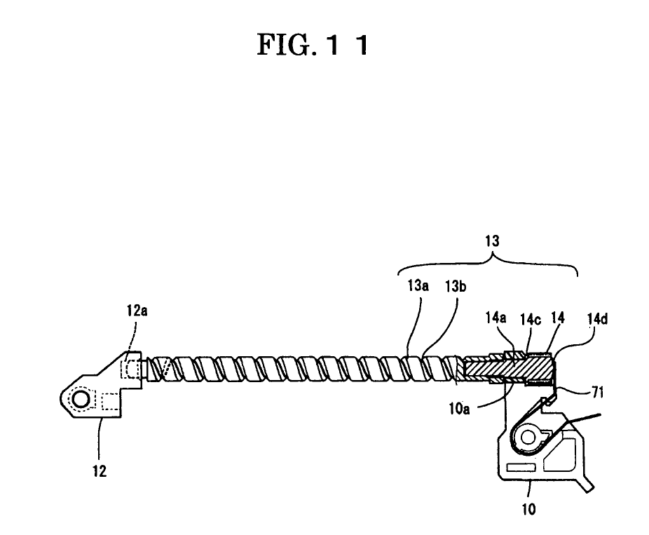

FIG. 11 is a view showing the feed screw according to the invention in details. Feed screw 13 made of a plastic material has a screw body 13a, a shaft part 14a screwed in one end part of the screw body 13a such as to be fitted for rotation in a hole 10a of a first securing member 10, a helical gear 14, a flange part 14c (i.e., stopper) formed at the boundary between the flange part 14a and the helical gear 14, and a protuberance 14d tapering toward the axis at the free end. On the first securing member 10 is provided a metal leaf spring 71 (i.e., elastic member) pushing the protuberance 14d in the axial direction of the protuberance 14d. The flange part 14c is held in contact with the edge of hole 10a by an urging force of the leaf spring 71, thus restricting axial displacement of the feed screw 13. The feed screw 13 is fitted at the other end for rotation in hole 12a of the second securing member 12. The hole 12a has such a depth that its bottom is not in contact with the other end of the feed screw 12a.

The urging force of the leaf spring 71 is applied only to the helical gear 14 between the protuberance 14d and the flange part 14c, and is not applied to the screw body 13a of the feed screw 13. Thus, the screw body 13a of the feed screw 13 made of even a plastic material has no possibility of being bent in a high temperature environment, and no change is caused in the rotation load on the holes 10a and 12a. Thus, even when the environment of use is changed, the rotation load on the feed screw is not increased, and the pick-up can be fed with a light load on it.

While the above embodiments have been described such that the screw body 13a of the feed screw 13 has the helical groove 13b, it is possible to replace the helical groove 13b with a helical hill. In this case, two hill teeth of a spur gear are formed as engagement part.

While the invention is useful for a pick-up drive apparatus for a disc player incorporating a tilt adjustment mechanism for playing back DVDs, it can also be utilized for a disc player incorporating no tilt adjustment mechanism for paying back usual CDs.

What is claimed is:

1. A pick-up drive apparatus for a disc player comprising a feed screw (13) axially biased at one end thereof by an elastic member (10b), a guide shaft (5) disposed side by side with said feed screw, a coupling member (2) having an engagement part (22a) in radial and elastically forced contact with said feed screw and capable of being advanced and retreated in the axial direction of said feed screw with rotation thereof, and a pick-up (3) supported on a pick-up seat (4) capable of following said coupling member for advancement and retreat along said guide shaft, wherein:
said coupling member is mounted on said guide shaft for rocking movement about and axial advancement and retreat along said guide shaft;
said coupling member has a pair of clamping members (21b, 22) clamping said feed screw from the opposite sides thereof in the direction of rocking movement, said engagement part being formed on one of said clamping pieces; and
changes in the relative positions of the guide shaft and the feed screw are allowed by rocking movement of said coupling member and changes in the position of contact of said engagement part with said feed screw.

2. A pick-up drive apparatus for a disc player comprising a feed screw (13) axially biased at one end thereof by an elastic member (10b), a guide shaft (5) disposed side by side with said feed screw, a coupling member (5) having an engagement part in radial and elastically forced contact with said feed screw and capable of being advanced and retreated in the axial direction of said feed screw with rotation thereof, and a pick-up (3) supported on a pick-up seat (4) capable of following said coupling member for advancement and retreat along said guide shaft, wherein:
said coupling member (50) has a securing part (43) for securing said coupling member to said pick-up seat and a pair of clamping pieces (41,2) clamping said feed screw from the opposite sides in the direction of rocking movement;
said clamping member further has a reduced thickness part (46) between said securing part and said clamping pieces, said engagement part (45) being constituted by one of said clamping pieces; and
changes in relative positions of said guide shaft and said feed screw are allowed by rocking movement of said coupling member and changes in the position of contact of said engagement part with said feed screw.

3. A pick-up drive apparatus for a disc player a feed screw (13) axially biased at one end thereof by an elastic member (10b), a guide shaft (5) disposed side by side with said feed screw, a coupling member (51) having an engagement part in radial and elastically forced contact with said feed screw and capable of being advanced and retreated in the axial direction of said feed screw with rotation thereof, and a pick-up (3) supported on a pick-up seat (4) capable of following said coupling member for advancement and retreat along said feed shaft, wherein:
said coupling member (51) is supported to be rocked on said feed screw;
said coupling member has an elastic arm (51b) in elastic contact with said pick-up seat in the axial direction of said guide shaft; and
changes in the relative positions of said guide shaft and said feed screw are allowed by rocking movement of said coupling member and changes in the position of contact of said engagement part with said feed screw.

4. A pick-up drive apparatus for a disc player comprising a feed screw (13) axially biased at one end by an elastic member (10b), a guide shaft (5) disposed side by side with said feed screw, a coupling member (61) having an engagement part (63b) in radially and elastically forced contact with said feed screw and capable of being advanced and retreat in the axial direction of said feed screw with rotation thereof, and a pick-up supported on a pick-up seat capable of following said coupling member for advancement and retreat along said feed shaft, wherein:
said coupling member (61) is fitted on said pick-up seat for rocking movement such as to stride a central axis of said feed screw;
said coupling member has a pair of clamping pieces (62, 63) clamping said feed screw from the opposite sides in the direction of rocking movement; and
changes in the relative positions of said guide shaft and said feed screw are allowed by rocking movement of said coupling member and changes in the position of contact of said engagement part with said feed screw.

5. The pick-up drive apparatus for a disc player according to claim 1, wherein said guide shaft permits tilt adjustment.

6. The pick-up drive apparatus for a disc player according to claim 2, wherein said guide shaft permits tilt adjustment

7. The pick-up drive apparatus for a disc player according to claim 3, wherein said guide shaft permits tilt adjustment

8. The pick-up drive apparatus for a disc player according to claim 4, wherein said guide shaft permits tilt adjustment

9. The pick-up drive apparatus for a disc player according to claim 1, wherein said feed screw is made of a plastic material.

10. The pick-up drive apparatus for a disc player according to claim 2, wherein said feed screw is made of a plastic material.

11. The pick-up drive apparatus for a disc player according to claim 3, wherein said feed screw is made of a plastic material.

12. The pick-up drive apparatus for a disc player according to claim 4, wherein said feed screw is made of aplastic material.

13. The pick-up drive apparatus for a disc player according to claim 9, wherein said feed screw has a stopper (14c) formed on one end part of the feed screw, said stopper being in contact with a bearing part (10a) supporting one end part of said feed screw for rotation and receiving the biasing force of said elastic member.

14. The pick-up drive apparatus for a disc player according to claim 10, wherein said feed screw has a stopper (14c) formed on one end part, said stopper being in contact with a bearing part (10a) supporting one end part of said feed screw for receiving the biasing forcer of said elastic member.

15. The pick-up drive apparatus for a disc player according to claim 11, wherein said feed screw has a stopper (14c) fitted on one end part of the feed screw, said stopper being in contact with a bearing part (10a) supporting one end part of said feed screw for receiving the biasing force of said elastic member.

16. The pick-up drive apparatus for a disc player according to claim 12, wherein said feed screw has a stopper (14c) formed on one end part of the feed screw, said stopper being in contact with a bearing part (10a) supporting one and part of said feed screw for receiving the biasing force of said elastic member.

17. The pick-up drive apparatus for a disc player according to claim 1, wherein said coupling member has an elastic member (66) for holding said clamping pieces in forced contact with said feed screw.

18. The pick-up drive apparatus for a disc player according to claim 2, wherein said coupling member has an elastic member (66) for holding said clamping piece in forced contact with said feed screw.

19. The pick-up drive apparatus for a disc player according to claim 3, wherein said coupling member has an elastic member (66) for holding aid clamping pieces in forced contact with said feed screw.

20. The pick-up drive apparatus for a disc player according to claim 4, wherein said coupling member has an elastic member (66) for holding said clamping pieces in forced contact with said feed screw.
